(19) United States
(12) Patent Application Publication
(10) Pub. No.: US 2010/0097626 A1
(43) Pub. Date: Apr. 22, 2010

(54) METHOD AND MULTI-FUNCTION MACHINE HAVING THE CAPABILITY OF DISPLAYING COMMERCIAL CONTENT

(75) Inventor: John A. Moore, Rochester, NY (US)

Correspondence Address: Xerox Corporation (CDFS), 445 Broad Hollow Rd.-Suite 420, Melville, NY, 11747, US

(73) Assignee: Xerox Corporation, Norwalk, CT (US)

(21) Appl. No.: 12/253,604

(22) Filed: Oct. 17, 2008

(51) Int. Cl. G06F 3/12

(52) U.S. Cl. 358/1.13

(57) ABSTRACT

A method and a multi-function machine are provided for displaying commercial content and advertisements on the display screen when it is idle. The multi-function machine is of the type having the capability of scanning, copying and electronically transmitting documents. In particular, the multi-function machine includes a scanning assembly; a printer; a display; and a display content management module for managing commercial content received via at least one network connection for displaying by said display; and at least one processor configured to control said display to display said commercial content received via the at least one network connection and managed by said display content management module.

### BACKGROUND

The present disclosure relates to multi-function machines, and more particularly, to a method and a multi-function machine having the capability of displaying commercial content. As used herein, the term “commercial content” encompasses advertisements, coupons, promotional material, product brochures, and other content unrelated to the operation of the multi-function machine.

“Multi-functions” machines have become familiar in offices and in home computing environments. Whereas, previously, functions such as copying, printing, and facsimile transmission have been performed by single dedicated copiers, printers, and facsimiles, respectively, a multi-function machine is typically capable of providing all such functions and more in a single machine. Typically, such a multi-function machine includes a single print engine, which can serve to output copies, prints, or received facsimiles; as well as a single input scanner which can serve to record data from original images for use in copying, facsimile transmission, and retention of input image data to a predetermined location in a computer memory (“scan-to-file”).

Such multi-function machines are typically connected to data networks, such as the Internet, for exchange of both image data and associated operational instructions. Generally, many of the multi-function machines have some type of an active display for use as a user interface and many such devices use color flat panel displays with resolutions of 800×600 and higher. Usually, these machines are in high traffic areas and according to their amount of use, can sit idle for periods of time throughout the day. There is a need to use the idle periods of time, including other periods of time, for the multi-function machine to perform functions other than traditional functions of a multi-function machine. There is also a need to offset operating expenses of the multi-function machine.

### SUMMARY

The present disclosure provides a method and multi-function machine having the capability of displaying commercial content. As used herein, the term “commercial content” encompasses advertisements, coupons, promotional material, product brochures, and other content unrelated to the operation of the multi-function machine. In accordance with an embodiment of the present disclosure, the provider of the commercial content pays a fee to the operator (e.g., business owner) or service provider (e.g., leaser of the multi-function machine) to offset expenses necessary for operating the multi-function machine.

In particular, the present disclosure provides a multi-function machine having the capability of displaying and printing commercial content. The commercial content is received via at least one network connection, managed by a display content management module, and displayed on a display of the multi-function machine. The commercial content is displayed when the multi-function machine is idle, or at any other time of which the multi-function machine is programmed for displaying the commercial content. The commercial content is viewable by the operator, who has the option of printing such displayed commercial content via a printer of the multi-function machine.

The operator also has the option of performing other functions related to the displayed commercial content by transmitting an instruction to at least one processor via one of a control pad and the display. The other functions include, but are not limited to, requesting electronic transmission, such as via an email system, of the displayed commercial content to at least one electronic address; ordering a product advertised by the commercial content via a touch-screen icon or other means, such as consumables required to operate the multi-function machine; redeeming a coupon displayed by the commercial content; accepting an offer displayed by the commercial content; requesting temporary or permanent suspension of the transmission of further commercial content; requesting similar commercial content to be displayed by the display as commercial content displayed by the display; requesting additional information related to a product advertised by the displayed commercial content via electronic, facsimile, and/or snail mail delivery of such additional information; etc. The additional information can be requested by the operator touching an icon displayed by the display. The additional information can be electronically provided via a pop-up window displayed by the display, and/or access to a webpage of a particular website and displayed by the display.

The multi-function machine further includes a scanning assembly and communications circuitry for connecting to at least one network. The at least one processor is operable to control the various components and assemblies of the multi-function machine, including the display for displaying commercial content, in accordance with the present disclosure. The at least one processor is configured for executing programmable instructions of the content management module for managing and displaying the received commercial content. Upon its instructions being executed by the at least one processor, the display content management module determines the received commercial content to be displayed according to at least one predetermined parameter as further described below.

The processor is further operable to control the display for displaying the commercial content after a predetermined condition is satisfied. The predetermined condition may include the multi-function machine being idle for a predetermined amount of time; receipt of a manual request via one of the control pad and display; and clocking by the processor a predetermined amount of time from a pre-established time, such as from a time the multi-function machine completes a function.

The display content management module determines the received commercial content to be displayed in accordance with the at least one predetermined parameter; and arranges for the display of the received commercial content on the display. The predetermined parameter may include: time of day; location of the multi-function machine; type of business; and relation of the received commercial content to commercial content previously displayed and printed or otherwise previously indicated to be of interest to at least one operator or user of the multi-function machine.

The control pad enables a user to manually adjust service options, including selecting types of commercial content to be received, and compose and electronically transmit messages related to the displayed commercial content. The control pad also enables the operator or user to manually switch display screens from one display screen displaying the commercial content to one display screen displaying virtual buttons for performing at least one native function of the multi-function machine.

The present disclosure also provides a method for displaying commercial content received via at least one network connection on a display of a multi-function machine. The method includes the steps of receiving the commercial content from a remote server; determining if a predetermined condition has been satisfied; and displaying the received commercial content on the display of the multi-function machine if the predetermined condition has been satisfied. The predetermined condition may include the multi-function machine being idle for a predetermined amount of time; receipt of a manual request via one of a control pad and the display; and clocking by at least one processor a predetermined amount of time from a pre-established time, such as from a time the multi-function machine completes a function.

The method further includes managing the received commercial content and displaying the commercial content which satisfies at least one predetermined parameter. The predetermined parameter may include: time of day; location of the multi-function machine; type of business; and relation of the received commercial content to commercial content previously displayed and printed or otherwise previously indicated to be of interest to at least one operator or user of the multi-function machine.

The method further includes determining if an operator or user performed at least one action with respect to the displayed commercial content and charging a fee to at least one provider of the commercial content of which the operator or user performed the at least one action. The at least one action includes, but is not limited to, printing the commercial content; requesting electronic transmission, such as via an email system, of the displayed commercial content to at least one electronic address; ordering a product (such as consumables required to operate the multi-function machine) advertised by the commercial content via a touch-screen icon or other means; redeeming a coupon displayed by the commercial content; accepting an offer displayed by the commercial content; requesting temporary or permanent suspension of the display of further commercial content; requesting similar commercial content to be displayed by the display as commercial content displayed by the display; requesting additional information related to a product advertised by the displayed commercial content via electronic, facsimile, and/or snail mail delivery of such additional information; etc.

The additional information can be requested by the operator touching an icon displayed by the display. The additional information can be electronically provided via a pop-up window displayed by the display, and/or access to a webpage of a particular website and displayed by the display.

The present disclosure also provides a commercial content electronic delivery system for electronically delivering commercial content via a network to a plurality of multi-function machines. The system enables for the various commercial content to be tracked via unique identifiers assigned to the commercial content via at least one server. The commercial content that can be tracked includes, but is not limited to, coupons, promotional offers, and questionnaires. If the recipient performs at least one action with respect to the tracked commercial content, a data signal is transmitted to a remote server indicating the unique identifier, the specific action performed by the recipient, and the identity of the multi-function machine of which the action was performed. The data signal can be generated and transmitted to the remote server by the display content management module embedded within the multi-function machine. Subsequently, the system can be used for transmitting targeted commercial content to one or more multi-function machines of which one or more recipients performed the specific action, where the targeted commercial content is related to the commercial content of which the one or more recipients performed the specific action.

The present disclosure also provides a computer-readable medium storing a set of programmable instructions configured for being executed by at least one processor for performing a method for displaying commercial content received via at least one network connection on a display of a multi-function machine having the capability of receiving the commercial content from a remote server, determining if a predetermined condition has been satisfied, and displaying the received commercial content on the display of the multi-function machine, if the predetermined condition has been satisfied. The predetermined condition may include the multi-function machine being idle for a predetermined amount of time; receipt of a manual request via one of a control pad and the display; and clocking by the processor a predetermined amount of time from a pre-established time, such as from a time the multi-function machine completes a function.

The multi-function machine, method, computer-readable medium and system of the present disclosure overcome the drawbacks of prior art advertising methods and systems including those which provide for delivering commercial content via snail mail, and facsimile and email systems. Such prior art systems are expensive to operate and the commercial content is not likely to be read by the recipient, let alone, garner a response by the recipient. That is, commercial content delivered via snail mail, and facsimile and email systems are typically discarded or deleted without the recipient reading the commercial content. Additionally, prior art methods of delivering commercial content entail for the recipient to perform one or more intervening steps prior to being able to view the commercial content, such as opening an envelope, ensuring a facsimile machine has paper, and accessing an email or other electronic message.

### BRIEF DESCRIPTION OF THE DRAWINGS

Various embodiments of the present disclosure will be described herein below with reference to the figures wherein:

FIG. 1 is a block diagram depicting a system having a plurality of multi-function machines each having the capability of displaying commercial content in accordance with the present disclosure; and

FIG. 2 is a top view of a display of a multi-function machine displaying commercial content in accordance with the present disclosure.

### DETAILED DESCRIPTION

The present disclosure provides a method and multi-function machine having the capability of displaying commercial content. As used herein, the term “commercial content” encompasses advertisements, coupons, promotional material, product brochures, and other content unrelated to the operation of the multi-function machine. In accordance with an embodiment of the present disclosure, the provider of the commercial content pays a fee to the operator (e.g., business owner) or service provider (e.g., leaser of the multi-function machine) to offset expenses necessary for operating the multi-function machine and provide a profit to the operator or service provider.

It is envisioned that a multi-function machine in accordance with the present disclosure can be provided in a public area and deemed for public use, such as in a library or airport. Services capable of being provided by the multi-function machine, such as photocopying and electronically transmitting documents, can be offered to the public for free, since the expenses for operating and servicing the multi-function machine, including providing a profit to the operator or service provider, are effected by the fees collected from the providers of the commercial content.

The commercial content is received by the multi-function machine via at least one network connection, managed by a display content management module, and displayed on a display of the multi-function machine. The commercial content is displayed when the multi-function machine is idle, or at any other time of which the multi-function machine is programmed for displaying the commercial content. The commercial content is viewable by the operator, who has the option of printing such displayed commercial content via a printer of the multi-function machine.

The operator also has the option of performing other functions related to the displayed commercial content by transmitting an instruction to at least one processor via one of a control pad and the display. The other functions include, but are not limited to, requesting electronic transmission, such as via an email system, of the displayed commercial content to at least one electronic address; ordering a product advertised by the commercial content via a touch-screen icon or other means, such as consumables required to operate the multi-function machine; redeeming a coupon displayed by the commercial content; accepting an offer displayed by the commercial content; requesting temporary or permanent suspension of the transmission of further commercial content; requesting similar commercial content to be displayed by the display as commercial content displayed by the display; requesting additional information related to a product advertised by the displayed commercial content via electronic, facsimile, and/or snail mail delivery of such additional information; etc. The additional information can be requested by the operator touching an icon displayed by the display. The additional information can be electronically provided via a pop-up window displayed by the display, and/or access to a webpage of a particular website and displayed by the display.

The multi-function machine further includes a scanning assembly and communications circuitry for connecting to at least one network and establishing the at least one network connection. The at least one processor is operable to control the various components and assemblies of the multi-function machine, including the display for displaying commercial content, in accordance with the present disclosure. The at least one processor is configured for executing programmable instructions of the display content management module for managing and displaying the received commercial content. Upon its instructions being executed by the at least one processor, the display content management module determines the received commercial content to be displayed according to at least one predetermined parameter as further described below.

The processor is further operable to control the display for displaying the commercial content after a predetermined condition is satisfied. The predetermined condition may include the multi-function machine being idle for a predetermined amount of time; receipt of a manual request via one of the control pad and display; and clocking by the processor a predetermined amount of time from a pre-established time, such as from a time the multi-function machine completes a function.

The display content management module determines the received commercial content to be displayed in accordance with the at least one predetermined parameter; and arranges for the display of the received commercial content on the display. The predetermined parameter may include: time of day; location of the multi-function machine; type of business; and relation of the received commercial content to commercial content previously displayed and printed or otherwise previously indicated to be of interest to at least one operator or user of the multi-function machine.

The control pad enables a user to manually adjust service options, including selecting types of commercial content to be received, and compose and electronically transmit messages related to the displayed commercial content. The control pad also enables the operator or user to manually switch display screens from one display screen displaying the commercial content to one display screen displaying virtual buttons for performing at least one native function of the multi-function machine.

The present disclosure also provides a method for displaying commercial content received via at least one network connection on a display of a multi-function machine. The method includes the steps of receiving the commercial content from a remote server; determining if a predetermined condition has been satisfied; and displaying the received commercial content on the display of the multi-function machine if the predetermined condition has been satisfied. The predetermined condition may include the multi-function machine being idle for a predetermined amount of time; receipt of a manual request via one of a control pad and the display; and clocking by at least one processor a predetermined amount of time from a pre-established time, such as from a time the multi-function machine completes a function.

The method further includes managing the received commercial content and displaying the commercial content which satisfies at least one predetermined parameter. The predetermined parameter may include: time of day; location of the multi-function machine; type of business; and relation of the received commercial content to commercial content previously displayed and printed or otherwise previously indicated to be of interest to at least one operator or user of the multi-function machine.

The method further includes determining if an operator or user performed at least one action with respect to the displayed commercial content and charging a fee to at least one provider of the commercial content of which the operator or user performed the at least one action. The at least one action includes, but is not limited to, printing the commercial content; requesting electronic transmission, such as via an email system, of the displayed commercial content to at least one electronic address; ordering a product (such as consumables required to operate the multi-function machine) advertised by the commercial content via a touch-screen icon or other means; redeeming a coupon displayed by the commercial content; accepting an offer displayed by the commercial content; requesting temporary or permanent suspension of the display of further commercial content; requesting similar commercial content to be displayed by the display as commercial content displayed by the display; requesting additional information related to a product advertised by the displayed commercial content via electronic, facsimile, and/or snail mail delivery of such additional information; etc.

The additional information can be requested by the operator touching an icon displayed by the display. The additional information can be electronically provided via a pop-up window displayed by the display, and/or access to a webpage of a particular website and displayed by the display.

The present disclosure also provides a commercial content electronic delivery system for electronically delivering commercial content via a network to a plurality of multi-function machines. The system enables for the various commercial content to be tracked via unique identifiers assigned to the commercial content via at least one server. The commercial content that can be tracked includes, but is not limited to, coupons, promotional offers, and questionnaires. If the recipient performs at least one action with respect to the tracked commercial content, a data signal is transmitted to a remote server indicating the unique identifier, the specific action performed by the recipient, and the identity of the multi-function machine of which the action was performed.

The data signal can be generated and transmitted to the remote server by the display content management module embedded within the multi-function machine. The data transmitted by the data signal is stored by the system as tracked data. Subsequently, the system can use the tracked data for transmitting targeted commercial content to one or more multi-function machines of which one or more recipients performed the specific action, where the targeted commercial content is related to the commercial content of which the one or more recipients performed the specific action. The relation can include commercial content describing similar products, commercial content provided by the same provider, commercial content offering similar promotions, etc.

A fee can be charged to the at least one provider of the commercial content for offering the at least one provider the ability to electronically transmit commercial content to a plurality of users of multi-function machines using the commercial content electronic delivery system in accordance with the present disclosure. A fee can further be charged for providing the at least one provider of the commercial content with tracking data, and for electronically transmitting targeted commercial content to the one or more multi-function machines.

The present disclosure also provides a computer-readable medium storing a set of programmable instructions configured for being executed by at least one processor for performing a method for displaying commercial content received via at least one network connection on a display of a multi-function machine having the capability of receiving the commercial content from a remote server, determining if a predetermined condition has been satisfied, and displaying the received commercial content on the display of the multi-function machine, if the predetermined condition has been satisfied. The predetermined condition may include the multi-function machine being idle for a predetermined amount of time; receipt of a manual request via one of a control pad and the display; and clocking by the processor a predetermined amount of time from a pre-established time, such as from a time the multi-function machine completes a function. The computer-readable medium can include, but is not limited to, CD-ROMS, flash memory devices, hard drive memory devices, EEPROMs, etc.

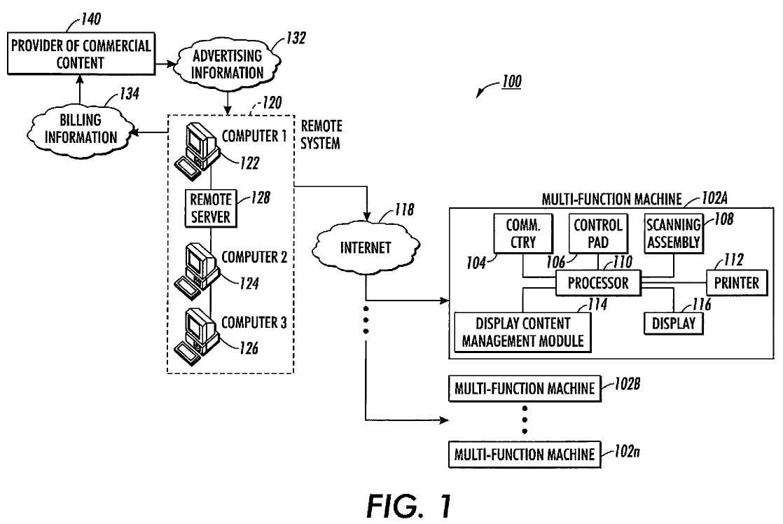

With reference to FIG. 1, there is depicted a block diagram of a commercial content electronic delivery system 100 having a plurality of multi-function machines 102A-n each capable for displaying commercial content on a display 116 for viewing by a user. A provider of commercial content, such as an advertiser 140, can utilize the system 100 for transmitting the commercial content to a particular multi-function machine 102A or to the plurality of multi-function machines 102A-102n from a remote system 120. The remote system 120 routes the commercial content through at least one network 118, such as the Internet, WAN, LAN, etc., to the multi-function machine 102A or machines 102A-102n. The commercial content is routed using conventional routing techniques, such as the remote system 120 generating and broadcasting data packets having at least one routing address corresponding to a multi-function machine 102A and the commercial content to be displayed.

The multi-function machines are of the type having the capability of scanning, copying and electronically transmitting documents, such as via facsimile and email transmission. The multi-function machines can be xerographic multi-function machines.

The provider 140 of the commercial content may be an entity, business, corporation, service provider, retailer and/or other individual desiring to transmit commercial content for display by the display 116 of the multi function machine 102A. The provider 140 of the commercial content provides the commercial content to a remote server 128 of the remote system 120 via at least one network 132.

It is contemplated that communications arc allowed to occur between the service provider of the remote system 120 and the commercial content provider 140 if the commercial content provider 140 is a trusted source and there is a contractual agreement between the two parties. The contractual agreement can provide for the payment of a fee from the provider 140 to the service provider of the remote system 120 for using the system 100 for electronically transmitting commercial content to at least one multi-function machine 102A. The provider 140 can be billed for the services to be rendered or services previously rendered via a billing network 134, which may be or include the same network 132 used for providing the commercial content to the remote system 120

The remote system 120 further includes at least one computer 122 in communication with the remote server 128. Although the remote system 120 is depicted in FIG. 1 with only a single remote server 128, it is envisioned that there may be a plurality of remote servers and the single remote server 128 should not be taken as a limitation.

The multi-function machine 102A further includes communications circuitry 104; a control pad 106; a scanning assembly 108; at least one processor 110; a printer 112; and a display content management module 114. Upon receipt of user input via one of the control pad 106 and the display 116, the processor 110 receives an instruction for performing a particular function of the multi-function machine 102.

One function that can be performed under the control of the processor 110 includes instructing the printer 112 to print commercial content displayed by the display 116. It is contemplated that the user can also instruct the processor 110 to instruct the printer 112 to print commercial content which is not displayed by the display 116 but which is stored within a memory of the multi-function machine 102A and managed by the display content management module 114.

Other functions that can be initiated by a user and performed under the control of the processor 110 include but are not limited to requesting electronic transmission, such as via an email system, of the displayed commercial content to at least one electronic address; ordering a product advertised by the commercial content via a touch-screen icon on the display 116 or other means, such as consumables required to operate the multi-function machine; redeeming a coupon displayed by the commercial content; accepting an offer displayed by the commercial content; requesting temporary or permanent suspension of the transmission of further commercial content; requesting similar commercial content to be displayed by the display as commercial content displayed by the display; requesting additional information related to a product advertised by the displayed commercial content via electronic, facsimile, and/or snail mail delivery of such additional information; etc. The additional information can be requested by the operator touching an icon displayed by the display 116. The additional information can be electronically provided via a pop-up window displayed by the display 116, and/or access to a webpage of a particular website and displayed by the display 116.

The display content management module 114 includes programmable instructions for managing received commercial content, including arranging the commercial content for display and printing; and tricking the commercial content of which a user performed at least one action, such as one of the actions described above.

The set of programmable instructions of the display content management module 114 can be application software stored within a memory, such as RAM and ROM, of the at least one processor 110, and/or a computer-readable medium, such as a hard drive, CD-ROM, flash memory, etc., readable by one or more reading devices of the multi-function machine 102A.

In an alternate embodiment, the function of arranging the commercial content for display and printing can be performed by incorporating within the display content management module 114 or connecting to the multi-function machine 102A a reduced size image generator. The generator arranges the received commercial content in a format suitable for printing, and displays the commercial content as a series of thumbnails on the display 116. The arranged thumbnails are transmitted by the reduced size image generator to the printer 112 after receiving a print instruction. The reduced size image generator can be the reduced size image generator described in co-pending and commonly owned U.S. patent application Ser. No. 10/776,620; the entire contents of which are incorporated herein by reference.

The at least one processor 110 of the multi-function machine 102 besides being in operable communication with the scanning assembly 108 and printer 112, and the display 116, it is further in operable communication with the control pad 106; and communication circuitry 104 for enabling the multi-function machine 102 to receive and transmit messages from and to one or more remote servers 128 via network 118.

The one or more servers 128 are linked to at least one computer 122. An operator can use the at least one computer 122 for programming the server 128 and/or to transmit original commercial content, or commercial content received via network 132, to the remote server 128. The at least one computer 122 can further store the tracked data relating to at least one action performed by at least one user in regards to commercial content displayed on the various displays 116 of the multi-function machines 102A-102n.

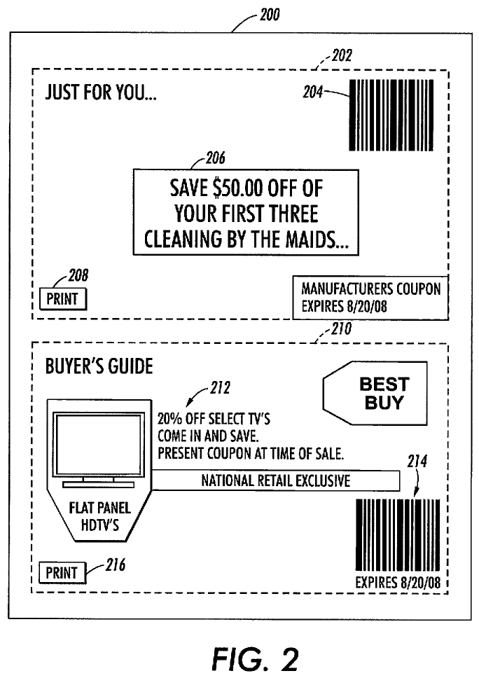

With reference to FIG. 2, there is shown a top view of the display 116 showing commercial content displayed thereon. In particular, the commercial content includes two blocks 202 and 210, each displaying commercial content.

In an exemplary method of operation of system 100, the display content management module 114 receives commercial content via network 118. The module 114 manages the received commercial content, which may include arranging the commercial content in a format suitable for displaying and determining whether the received commercial content is suitable for displaying on the display 116. The latter may be based on the type of business the multi-function machine 102A is being used by, such as law firm, accounting firm, restaurant, home office use, etc.

The module 114 may further determine that the commercial content is suitable for displaying at a particular time-of-day based on time-of-day display information transmitted along with the commercial content from the remote system 120. This time-of-day display information is processed by the module 114 and the corresponding commercial content is flagged by the module 114 for being displayed at the particular time-of-day. A system clock or an embedded clock within the multi-function machine 102A determines whether the particular time-of-day has been reached and accordingly notifies the module 114. After receiving notification, the module 114 retrieves the commercial content and transmits it to the processor 110 for display by display 116. The commercial content may be displayed for a predetermined amount of time or until a user of the multi-function machine 102A instructs the processor 110 to temporarily or permanently cease displaying that particular commercial content.

The module 114 may also determine the particular time of day for displaying the commercial content based on key words contained within the commercial content and identified by the module 114. Such words may include, for example, “dinner menu,” and “lunch special.” The former words identify the commercial content as relating to dinner and for the corresponding commercial content to be displayed during after lunch hours, and where the latter words identify the commercial content as relating to lunch and for the corresponding commercial content to be displayed after breakfast hours.

The module 114 may further determine whether or not to display the received commercial content based on whether or not the received commercial content is related to commercial content previously displayed and printed by a user, or otherwise indicated by some other action to be of interest to the user. Such determination may be made by the module 114 based on one or more identifiers assigned to the various commercial content by the remote system 120.

For example, the remote system 120 may assign the identifier ELEC for commercial content related to electronic products and equipment; FOOD for commercial content related to food products and restaurants; COUPON for commercial content having at least one coupon; and OFFER for commercial content having at least one promotional offer. Therefore, if a user within the last two weeks printed commercial content assigned the identifier ELEC, the module 114 would flag any newly received commercial content assigned the identifier ELEC for display by the display 116. On the other hand, if a user within the last two weeks has performed no action with respect to commercial content assigned the identifier FOOD, the module 114 would flag any newly received commercial content assigned the identifier FOOD not to be displayed by the display 116.

With continued reference to FIG. 2, block 202 includes a coupon/offer displayed by box 206 with an accompanying bar code 204 for cleaning services. Block 202 can be printed by the printer 112 of the multi-function machine 102A by touching the “PRINT” virtual button 208. The bar code 204 or other unique identifier provided within block 202 can enable tracking of the coupon, i.e., whether it was redeemed, for marketing, sales or other related purposes.

Block 210 includes a coupon/offer 212 with an accompanying bar code 214 for televisions. Block 210 can be printed by the printer 112 by touching the “PRINT” virtual button 216. It is contemplated that if virtual button 208 and 216 are touched simultaneously, then both blocks 202 and 210 are printed by printer 112.

As described above, the commercial content displayed by blocks 202 and 210 can be determined for display by the display content management module 114 based on parameters, such as whether a user of the multi-function machine 102A previously indicated an interest in commercial content related to the commercial content corresponding to blocks 202 and 210.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A multi-function machine of the type having the capability of scanning, copying and electronically transmitting documents, the multi-function machine comprising:
a scanning assembly;
a printer;
a display;
a display content management module for managing commercial content received via at least one network connection for displaying by said display; and
a processor operable to control said display to display said commercial content received via the at least one network connection and managed by said display content management module.

2. The multi-function machine according to claim 1, wherein the commercial content received via the at least one network connection comprises essentially of advertisements, coupons, promotional material, product brochures, and other content unrelated to the operation of the multi-function machine.

3. The multi-function machine according to claim 1, further comprising a control pad, wherein said processor receives an instruction from said one of said control pad and said display and in accordance with said received instruction said processor controls said multi-function machine.

4. The multi-function machine according to claim 3, wherein said instruction includes performing a task selected from the group consisting of printing by said printer commercial content displayed by said display; electronically transmitting commercial content displayed by said display to at least one electronic address; and transmitting an electronic message to a remote server via the at least one network connection requesting additional information relating to commercial content displayed by said display.

5. The multi-function machine according to claim 3, wherein said instruction includes performing a task selected from the group consisting of requesting similar commercial content to be displayed by said display as commercial content displayed by said display; ordering a product advertised by commercial content displayed by said display; redeeming a coupon displayed by commercial content displayed by said display; accepting an offer displayed by commercial content displayed by said display; and requesting temporary or permanent suspension of the transmission of commercial content to said multi-function machine.

6. The multi-function machine according to claim 1, wherein said processor is further operable to control said display for displaying said commercial content after a predetermined condition is satisfied.

7. The multi-function machine according to claim 6, wherein the predetermined condition is selected from the group consisting of said multi-function machine being idle for a predetermined amount of time, receipt of a manual request via one of a control pad and said display for displaying said commercial content received by said at least one network connection, and clocking by said processor a predetermined amount of time from a pre-established time.

8. The multi-function machine according to claim 1, wherein said display content management module assigns a unique identifier to said commercial content.

9. The multi-function machine according to claim 1, wherein said display content management module determines said commercial content to be displayed in accordance with at least one predetermined parameter.

10. The multi-function machine according to claim 9, wherein the at least one predetermined parameter is selected from the group consisting of time of day, location of said multi-function machine, type of business, and relation to commercial content previously displayed and printed or otherwise indicated to be of interest to at least one user.

11. The multi-function machine according to claim 1, further comprising a control pad, wherein said control pad enables a user to manually adjust service options, including selecting types of commercial content to be received and not to be received, and compose and electronically transmit messages related to said displayed commercial content.

12. The multi-function machine according to claim 1, further comprising a control pad, wherein one of said control pad and display enables a user to manually switch display screens from one display screen displaying said commercial content to one display screen displaying virtual buttons for performing at least one native function of said multi-function machine.

13. The multi-function machine according to claim 1, wherein the multi-function machine is a xerographic multi-function machine.

14. A method for displaying commercial content received via at least one network connection on a display of a multi-function machine, the method comprising the steps of:
receiving said commercial content from a remote server;
determining if a predetermined condition has been satisfied; and
displaying the received commercial content on said display of the multi-function machine, if said predetermined condition has been satisfied.

15. The method according to claim 14, wherein the predetermined condition I is selected from the group consisting of said multi-function machine being idle for a predetermined amount of time; receipt of a manual request via one of a control pad and said display for displaying said commercial content received by said at least one network connection; and clocking by said processor a predetermined amount of time from a pre-established time.

16. The method according to claim 14, further comprising managing the received commercial content and displaying commercial content which satisfies at least one predetermined parameter.

17. The method according to claim 16, wherein the at least one predetermined parameter is selected from the group consisting of time of day, location of said multi-function machine, type of business, and relation to commercial content previously displayed and printed or otherwise indicated to be of interest to at least one user.

18. The method according to claim 14, further comprising charging a fee to at least one provider of said commercial content.

19. The method according to claim 14, further comprising determining if a user performed at least one action with respect to said displayed commercial content, and charging a fee to at least one provider of said commercial content of which said user performed said at least one action with respect to said displayed commercial content.

20. The method according to claim 19, wherein the at least one action is selected from the group consisting printing said commercial content; ordering a product mentioned by said commercial content; requesting additional information related to said commercial content; requesting similar commercial content as commercial content displayed by said display; ordering a product advertised by commercial content displayed by said display; requesting temporary or permanent suspension of the transmission of commercial content to said multi-function machine; electronically transmitting said commercial content to at least one electronic address; redeeming a coupon displayed by said commercial content; and accepting an offer displayed by said commercial content.

21. The method according to claim 14, further comprising collecting data related to user-interaction with said displayed commercial content and providing said data to a provider of said commercial content.

22. The method according to claim 14, further comprising assigning an identifier to said commercial content and tracking said commercial content via said identifier.

23. A commercial content electronic delivery system comprising:
a remote server;
at least one network;
a plurality of multi-function machines in operative communication with said remote server via said at least one network, each of said plurality of multi-function machines being of the type having the capability of scanning, copying and electronically transmitting documents, each of the plurality of multi-function machines comprising:
a scanning assembly;
a printer;
a display;
a display content management module for managing commercial content received via said at least one network for displaying by said display; and
a processor operable to control said display to display said commercial content received via the at least one network and managed by said display content management module.

24. The system according to claim 23, further comprising means for assigning an identifier to said commercial content, means for tracking said commercial content via said identifier, and means for transmitting targeted commercial content related to the commercial content assigned said identifier in response to a recipient of said commercial content performing at least one action.

25. A computer-readable medium storing a set of programmable instructions configured for execution by at least one processor for displaying commercial content received via at least one network connection on a display of a multi-function machine, the method comprising the steps of:
receiving said commercial content from a remote server;
determining if a predetermined condition has been satisfied; and
displaying the received commercial content on said display of the multi-function machine, if said predetermined condition has been satisfied.

26. The method according to claim 25, wherein the predetermined condition I is selected from the group consisting of said multi-function machine being idle for a predetermined amount of time; receipt of a manual request via one of a control pad and said display for displaying said commercial content received by said at least one network connection; and clocking by said processor a predetermined amount of time from a pre-established time.
